(19) United States
(12) Patent Application Publication
(10) Pub. No.: US 2022/0274121 A1
(43) Pub. Date: Sep. 1, 2022

(54) ELECTROSTATIC COATING HANDGUN AND ELECTROSTATIC COATING METHOD

(71) Applicant: TOYOTA JIDOSHA KABUSHIKI KAISHA, Toyota-shi (JP)

(72) Inventors: Kazuki TANAKA, Toyota-shi (JP); Shinji TANI, Toyota-shi (JP)

(73) Assignee: TOYOTA JIDOSHA KABUSHIKI KAISHA, Toyota-shi (JP)

(21) Appl. No.: 17/571,934

(22) Filed: Jan. 10, 2022

(30) Foreign Application Priority Data
Feb. 26, 2021 (JP) 2021-029369

(51) Int. Cl. B05B 5/04; B05B 5/053; B05B 5/00; B05B 3/10

(52) U.S. Cl. CPC B05B 5/0407; B05B 5/0531; B05B 5/006; B05B 3/1085

(57) ABSTRACT

An electrostatic coating handgun sprays electrically charged atomized paint onto an object to be coated. The electrostatic coating handgun includes: a rotating head; a motor that applies rotational power to the rotating head; a high voltage generator that applies a voltage to the paint; a housing supporting the rotating head with a tip end of the rotating head being exposed, and housing the motor and the high voltage generator; and a grip portion to be held by an operator. When a current value discharged from the rotating head increases due to movement of the rotating head caused by an operation by the operator, a voltage control device reduces an output voltage of the high voltage generator and a motor control device reduces a rotational speed of the motor.

### BACKGROUND

### 1. Technical Field

The present disclosure relates to electrostatic coating handguns and electrostatic coating methods for spraying electrically charged atomized paint onto an object to be coated.

### 2. Description of Related Art

In recent years, electrostatic spray coating that provides high coating quality has been automated by robots, but electrostatic spray coating by operators using an electrostatic coating spray gun (electrostatic coating handgun) is still widely used.

Such electrostatic coating handguns that are used for electrostatic spray coating by operators are typically of the type that does not use a rotating head called a bell. However, there are also electrostatic coating handguns of the type that use a rotating head. For example, Japanese Unexamined Patent Application Publication No. 9-070557 (JP 9-070557 A) discloses an electrostatic coating handgun includes a handgun bracket and a bell type rotating atomizing head. The handgun bracket has a grip portion housing a high voltage generator, and a body portion in which an air motor is located. The bel type rotating atomizing handgun is attached to a tip end of a rotating shaft that is coupled to and driven by the air motor. A protective cover is located outside the bell type rotating atomizing head.

### SUMMARY

According to the above JP 9-070557 A, in the electrostatic coating handgun using the rotating head, the high voltage generator is housed in the grip portion. The body portion can thus be reduced in size. Moreover, since the rotating shaft supports the bell type rotating atomizing head, air bearings etc. can be eliminated, and reduction in weight can be achieved. Furthermore, since the protective cover is located outside the bell type rotating atomizing head (rotating head), the operator can be prevented from contacting a tip end of the handgun by accident. Safety is thus ensured.

In electrostatic coating handguns that spray electrically charged atomized paint onto an object to be coated, an increased voltage tends to be applied to the paint in order to improve the coating efficiency. In the case where electrostatic coating handguns have such a protective cover outside the rotating head as in JP 9-070557 A, the paint scatters toward the protective cover when an increased voltage is applied to the paint. This may end up reducing the coating efficiency.

In the electrostatic coating handgun of JP 9-070557 A in which the protective cover is located outside the rotating head, both reduction in size and weight and safety may be achieved. However, there is room for improvement as it is difficult to achieve both improvement in coating efficiency and safety.

The present disclosure provides a technique that achieve both improvement in coating efficiency and safety in an electrostatic coating handgun and an electrostatic coating method.

In an electrostatic coating handgun and an electrostatic coating method according to the present disclosure, an output voltage of a high voltage generator and a rotational speed of a rotating head are controlled according to the distance between an operator etc. and the rotating head.

Specifically, the present disclosure relates to an electrostatic coating handgun that sprays electrically charged atomized paint onto an object to be coated.

This electrostatic coating handgun includes: a rotating head having on a tip end of the rotating head a groove through which the paint is discharged; a motor configured to apply rotational power to the rotating head; a high voltage generator configured to apply a voltage to the paint; a housing supporting the rotating head with the tip end of the rotating head being exposed, and housing the motor and the high voltage generator; and a grip portion to be held by an operator; a voltage control device configured to reduce an output voltage of the high voltage generator when a current value discharged from the rotating head increases due to movement of the rotating head caused by an operation by the operator; and a motor control device configured to reduce a rotational speed of the motor when the current value discharged from the rotating head increases due to the movement of the rotating head caused by the operation by the operator.

According to this configuration, the rotating head having on the tip end of the rotating head the groove through which the paint is discharged is supported by the housing with the tip end of the rotating head being exposed. Accordingly, the discharged paint is more likely to be directed toward the object to be coated without scattering, as compared to the case where a protective cover etc. that covers the rotating head is provided. The coating efficiency is therefore improved.

When the voltage of the high voltage generator is approximately constant, the value of the current discharged from the rotating head (current flowing from the high voltage generator) varies according to a spatial resistance value between the object to be coated that is located in front of the rotating head, the operator, etc. and the rotating head. It is known that the spatial resistance value becomes smaller as the distance between the object to be coated, the operator, etc. and the rotating head decreases.

Therefore, according to this configuration, the voltage control device reduces the output voltage of the high voltage generator when the current discharged from the rotating head increases due to the movement of the rotating head (due to the rotating head approaching the object to be coated or the operator) caused by the operation by the operator. In this case, the motor control device reduces the rotational speed of the motor in response to the increase in current discharged from the rotating head. This configuration reduces the possibility that the rotating head rotating at high speed may contact the object to be coated, the operator, etc. Safety is thus ensured.

According to the electrostatic coating handgun of the present disclosure, both improvement in coating efficiency and safety can be achieved.

In the above electrostatic coating handgun, the voltage control device may be configured to control the output voltage of the high voltage generator to zero when an amount of change per unit time in the current value discharged from the rotating head is larger than a predetermined amount of change or when an absolute value of the current value is larger than a predetermined value, and the motor control device may be configured to stop rotation of the motor when the amount of change per unit time in the current value discharged from the rotating head is larger than the predetermined amount of change or when the absolute value of the current value is larger than the predetermined value.

According to this configuration, in a more urgent situation than a situation where the rotating head normally approaches the object to be coated, the operator, etc., specifically, when the amount of change per unit time in the current value is large (when the rotating head has rapidly approached the object to be coated, the operator, etc.) or when the absolute value of the current value is large (when the distance between the object to be coated, the operator, etc. and the rotating head is extremely short), the output voltage of the high voltage generator is controlled to zero and the rotation of the motor is stopped. This can prevent the operator from getting an electric shock, a cut, etc. Safety during electrostatic coating is thus ensured to a greater extent.

In the above electrostatic coating handgun, the motor control device may configured to use a brake mechanism when stopping the rotation of the motor.

According to this configuration, even when it is difficult to deal with a sudden decrease in the rotational speed of the motor by merely sending an output stop command to the motor, the rotation of the motor can be stopped more quickly and more reliably by using the brake mechanism. Safety is thus more reliably ensured.

The electrostatic coating handgun may be configured to electrostatically atomize the paint without using shaping air.

When atomizing the paint with shaping air, there is air moving from a base end side (rear side) toward a tip end side (front side). In this case, even if the rotating head is provided with a protective cover, a decrease in coating efficiency would be small. As described above, in the electrostatic coating handgun of the present disclosure, both safety and improvement in coating efficiency can be achieved without using such a protective cover. Accordingly, the present disclosure is suitably used for an electrostatic atomization type handgun that electrostatically atomizes paint without using shaping air.

The present disclosure also relates to an electrostatic coating method in which electrically charged atomized paint is sprayed onto an object to be coated.

In this electrostatic coating method, an electrostatic coating handgun is prepared. The electrostatic coating handgun includes: a rotating head having on a tip end of the rotating head a groove through which the paint is discharged; a motor configured to apply rotational power to the rotating head; a high voltage generator configured to apply a voltage to the paint; a housing supporting the rotating head with the tip end of the rotating head being exposed, and housing the motor and the high voltage generator; and a grip portion to be held by an operator.

In this electrostatic coating method, an output voltage of the high voltage generator and a rotational speed of the motor are reduced when a current value discharged from the rotating head increases due to movement of the rotating head caused by an operation by the operator when the operator sprays the paint onto the object to be coated by using the electrostatic coating handgun.

According to this configuration, the output voltage of the high voltage generator and the rotational speed of the motor are reduced when the current discharged from the rotating head increases due to, for example, the rotating head approaching the object to be coated or the operator). This configuration reduces the possibility that the rotating head rotating at high speed may contact the object to be coated, the operator, etc. Safety is thus ensured.

As described above, according to the electrostatic coating handgun and the electrostatic coating method according to the present disclosure, both improvement in coating efficiency and safety can be achieved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically shows an electrostatic coating device including an electrostatic coating handgun according to an embodiment of the present disclosure;

FIG. 2 is a schematic sectional view of a rotating head;

FIG. 3 is a schematic perspective view of a tip end of the rotating head;

FIG. 4 schematically illustrates an electrostatic field formed between the rotating head and an object to be coated; and

FIG. 5 is a flowchart showing an example of safety control that is performed by the electrostatic coating device.

### DETAILED DESCRIPTION OF EMBODIMENTS

A mode for carrying out the disclosure will be described below with reference to the drawings.

Electrostatic Coating Device

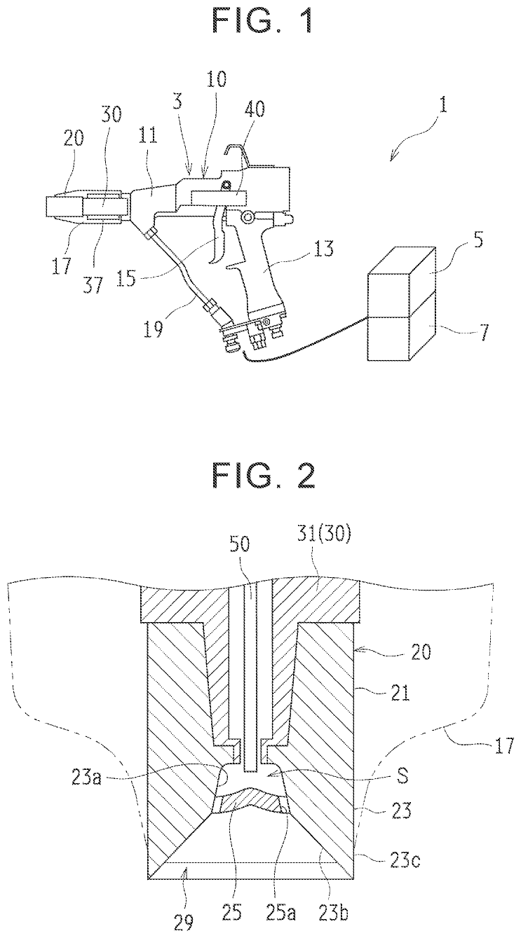

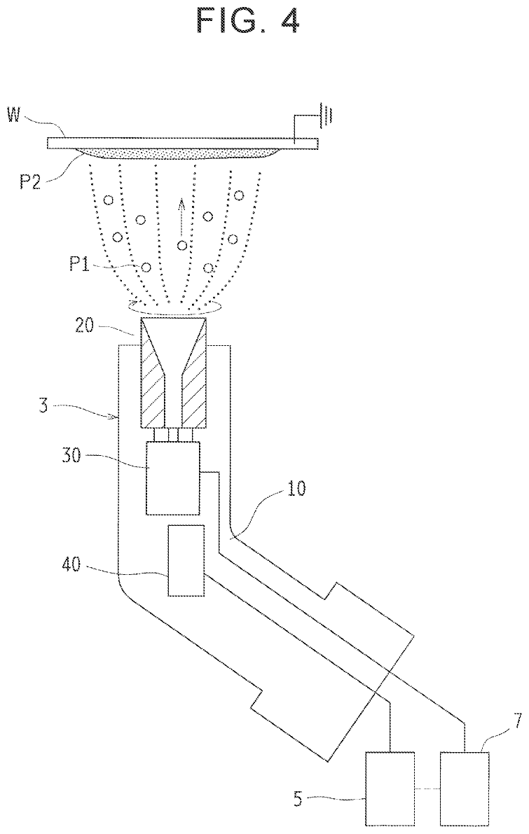

FIG. 1 schematically shows an electrostatic coating device 1 including an electrostatic coating handgun 3 according to an embodiment. The electrostatic coating device 1 is an electrostatic atomization type coating device that electrostatically atomizes paint P1 (see FIG. 4). As shown in FIG. 1, the electrostatic coating device 1 includes the electrostatic coating handgun 3, a high voltage controller 5, an air motor controller 7, an air supply device (not shown), and a paint supply device (not shown).

The electrostatic coating handgun 3 is a device that sprays electrically charged atomized paint P1 onto a workpiece (object to be coated) W (see FIG. 4) by a manual operation by an operator holding the electrostatic coating handgun 3. The electrostatic coating handgun 3 is connected to the high voltage controller 5 and the air motor controller 7. The air supply device supplies high pressure air to the electrostatic coating handgun 3. The high pressure air serves as a rotational driving source for a rotating head 20 of the electrostatic coating handgun 3. The paint supply device supplies the water-based paint P1 for electrostatic atomization coating to the electrostatic coating handgun 3. The paint P1 is, for example, paint made of a resin containing water.

As shown in FIG. 1, the electrostatic coating handgun 3 includes the rotating head 20, an air motor 30, a high voltage generator 40, and a housing 10. The housing 10 supports or houses the rotating head 20, the air motor 30, and the high voltage generator 40.

The housing 10 has a body portion 11, a grip portion 13 to be held by the operator, a trigger 15, and a cap 17. The body portion 11 is made of an electrically insulating material such as electrically insulating resin. The rotating head 20 is supported by a tip end of the body portion 11 with a tip end of the rotating head 20 exposed. The air motor 30 is housed behind (on the base end side of) the rotating head 20 in the body portion 11. The high voltage generator 40 is housed near the grip portion 13 in the body portion 11. The grip portion 13 is made of an electrically conductive material such as electrically conductive resin and is grounded by a ground wire (not shown), so that electric charge will not accumulate on the operator's body even when the operator holds the grip portion 13. When the operator holding the grip portion 13 pulls the trigger 15, the trigger 15 opens a trigger valve (not shown) to supply the paint P1 supplied from the paint supply device to the body portion 11 through a paint supply hose 19 to the rotating head 20 through a paint supply pipe 50 that will be described later. The cap 17 is attached to the tip end of the body portion 11. The cap 17 covers the outer peripheral surface of the rotating head 20 except the tip end of the rotating head 20 and also covers a part of the air motor 30.

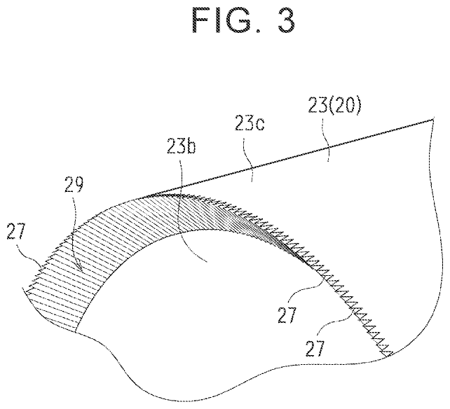

FIG. 2 is a schematic sectional view of the rotating head 20. The rotating head 20 has, in its tip end (grooved portion 29), grooves 27 (see FIG. 3) for emitting the paint P1. The rotating head 20 emits the supplied liquid paint P1 by centrifugal force generated by rotation of the rotating head 20. As shown in FIG. 2, the rotating head 20 has a generally cylindrical shape, and includes an attachment portion 21 in the base end side (rear side) of the rotating head 20 and a head portion 23 in the tip end side (front side) of the rotating head 20. The diameter of the rotating head 20 is, for example, 20 to 50 mm. The attachment portion 21 is fitted on a rotating shaft 31 of the air motor 30. The rotating shaft 31 of the air motor 30 is a hollow shaft, and the paint supply pipe 50 for supplying the paint P1 to the head portion 23 is located inside the rotating shaft 31.

The head portion 23 has a first inner peripheral surface 23a, a second inner peripheral surface 23b, and an outer peripheral surface 23c. The first inner peripheral surface 23a is shaped like a tapered surface of a truncated cone, and the diameter of the first inner peripheral surface 23a increases as it gets closer to the tip end of the head portion 23. The second inner peripheral surface 23b extends from the tip end of the first inner peripheral surface 23a and is also shaped like a tapered surface of a truncated cone. The diameter of the second inner peripheral surface 23b increases at a higher rate than the diameter of the first inner peripheral surface 23a as it gets closer to the tip end of the head portion 23. The outer peripheral surface 23c has a generally cylindrical surface. A hub 25 is provided radially inside the first inner peripheral surface 23a, and a paint space S is defined by the first inner peripheral surface 23a and the hub 25. A tip end of the paint supply pipe 50 faces the paint space S. The hub 25 has, in its outer edge portion, an outlet hole 25a through which the paint P1 flows out of the paint space S. The second inner peripheral surface 23b functions as a diffusion surface by which the paint P1 having flowed out of the paint space S through the outlet hole 25a is diffused by centrifugal force. The second inner peripheral surface 23b has the grooved portion 29 in its tip end. The grooved portion 29 has the grooves 27.

FIG. 3 is a schematic perspective view of the tip end of the rotating head 20. The grooves 27 are provided in order to emit the paint P1 in the form of filaments. Specifically, the grooves 27 extend in the axial direction to the tip end (front end) of the rotating head 20 and are tilted radially outward along the second inner peripheral surface 23b. The grooves 27 (e.g., 600 to 1200 grooves) are provided in the circumferential direction. Each groove 27 has a V-shaped (triangular) cross section. The cross section of each groove 27 appears on the outer peripheral surface 23c. The tip end of the rotating head 20 therefore has a jagged edge as viewed from the outer peripheral surface 23c side.

As described above, the air motor 30 is located behind the rotating head 20 in the body portion 11 of the housing 10 and the rotating shaft 31 of the air motor 30 is connected to the rotating head 20, so that the air motor 30 applies rotational power to the rotating head 20 using high-pressure air supplied from the air supply device. The air motor 30 is relatively small in order to reduce the burden on the operator. The air motor controller 7 controls the rotational speed of the air motor 30. As shown in FIG. 1, a brake mechanism 37 is provided around the air motor 30. The brake mechanism 37 stops the rotation of the air motor 30 by holding the rotating shaft 31.

The high voltage generator 40 is a device that applies a voltage to the paint P1. The high voltage generator 40 negatively charges the rotating head 20 by generating a negative high voltage and applying it to the rotating head 20. A strong electrostatic field is thus formed between the rotating head 20 serving as a negative electrode and the grounded workpiece W serving as a positive electrode.

FIG. 4 schematically illustrates an electrostatic field formed between the rotating head 20 and the workpiece W. FIG. 4 merely illustrates the electrostatic field and does not accurately show the shape of the electrostatic coating handgun 3 and the arrangement of the main functional parts in the electrostatic coating handgun 3. The paint P1 emitted in the form of filaments from the rotating head 20 is electrostatically atomized as it breaks up into droplets by the electrostatic force of the electrostatic field formed between the rotating head 20 and the workpiece W. As shown in FIG. 4, the paint P1 thus electrostatically atomized is attracted and adheres to the grounded workpiece W due to the negative charge of the paint P1. As a result, a coating film P2 is formed on the surface of the workpiece W.

As described above, in the present embodiment, the paint P1 is electrostatically atomized by the electrostatic force in the electrostatic field formed between the rotating head 20 and the workpiece W without using shaping air. Accordingly, the coating efficiency is improved as the paint particles adhering to the workpiece W and the paint particles floating near the workpiece W are not lifted by the airflow accompanying the shaping air. Moreover, generating ionic wind from the tip end of the rotating head 20 by glow discharge can assist stable flight and pattern formation of the atomized paint P1.

The high voltage generator 40 is relatively small, and as shown in FIG. 1, is located near the grip portion 13, namely away from the rotating head 20 and the air motor 30 that need to be disposed in the tip end of the electrostatic coating handgun 3. The electrostatic coating handgun 3 has such a balanced center of gravity that the operator holding the grip portion 13 is less likely to feel the weight. The electrostatic coating handgun 3 thus has a structure that does not impose a burden on the operator. Moreover, since the high voltage generator 40 is placed near the grip portion 13 so as to be away from the tip end of the electrostatic coating handgun 3, electrical insulation can be provided while allowing efficient voltage application to the paint P1.

The high voltage controller (voltage control device) 5 controls the output voltage of the high voltage generator 40 to adjust the strength of the electrostatic field in order to control the particle size of the paint P1 to be electrostatically atomized to the particle size suitable for coating or to reduce variation in particle size of the paint P1 to be electrostatically atomized. For example, when the high voltage controller 5 increases the output voltage of the high voltage generator 40 to increase the strength of the electrostatic field, the electrostatic force is increased and the particle size of the paint P1 to be electrostatically atomized is therefore reduced. On the other hand, when the high voltage controller 5 reduces the output voltage of the high voltage generator 40 to reduce the strength of the electrostatic field, the electrostatic force is reduced and the particle size of the paint P1 to be electrostatically atomized is therefore increased. For example, the particle size suitable for coating is preferably 20 to 30 μm in Sauter mean diameter (SMD).

The coating pattern (coating area) can also be controlled by adjusting the strength of the electrostatic field by the high voltage controller 5. For example, when the strength of the electrostatic field is increased by the high voltage controller 5, the electrostatically atomized paint P1 is driven more straight, and the coating pattern therefore becomes narrow. On the other hand, when the strength of the electrostatic field is decreased by the high voltage controller 5, the electrostatically atomized paint P1 is driven less straight, and the coating pattern therefore becomes wide.

If the high voltage controller 5 controls the output voltage of the high voltage generator 40 so that the potential at the open end of the rotating head 20 is always constant, the potential difference V would be fixed. The electric field strength E therefore would change according to a change in distance between the workpiece W and the rotating head 20. As a result, the particle size of the paint P1 to be electrostatically atomized would vary. Accordingly, the electrostatic atomization of the paint P1 would become unstable and the coating efficiency also would become unstable.

In the present embodiment, the high voltage controller 5 controls the output voltage of the high voltage generator 40 so that the current (discharge current) discharged from the open end of the rotating head 20 is always constant. Since the potential difference V is changed according to a change in distance between the workpiece W and the rotating head 20, fluctuations in electric field strength E are reduced. Specifically, as the distance between the workpiece W and the rotating head 20 increases, a resistance component R (spatial resistance value) for the discharge current I increases. The high voltage controller 5 therefore controls the high voltage generator 40 so that the output voltage of the high voltage generator 40 increases (the potential difference V (=R I) increases) as the distance between the workpiece W and the rotating head 20 increases.

On the other hand, as the distance between the workpiece W and the rotating head 20 decreases, the resistance component R (spatial resistance value) for the discharge current I decreases. The high voltage controller 5 therefore controls the high voltage generator 40 so that the output voltage of the high voltage generator 40 decreases (the potential difference V (=R×I) decreases) as the distance between the workpiece W and the rotating head 20 decreases. In other words, when the current value that is discharged from the rotating head 20 increases due to the movement of the electrostatic coating handgun 3 (rotating head 20) caused by an operation by the operator, the high voltage controller 5 reduces the output voltage of the high voltage generator 40.

Fluctuations in electric field strength E are thus reduced, and as a result, variation in particle size of the paint P1 to be electrostatically atomized is reduced. Accordingly, the electrostatic atomization of the paint P1 can be stabilized, and the coating efficiency can also be stabilized.

The air motor controller (motor control device) 7 is connected to the electrostatic coating handgun 3, and controls the rotational speed of the air motor 30 as described above. The air motor controller 7 is electrically connected to the high voltage controller 5, and sends and receives information to and from the high voltage controller 5.

When coating the workpiece W using the electrostatic coating device 1 configured as described above, the electrostatic coating device 1 is first started to rotate the rotating head 20 at high speed and to apply a negative high voltage to the rotating head 20. A static electric field is thus formed between the rotating head 20 and the workpiece W. Next, the operator pulls the trigger 15. The trigger valve thus opens, so that the paint P1 supplied from the paint supply device to the body portion 11 through the paint supply hose 19 is supplied to the rotating head 20 through the paint supply pipe 50.

The paint P1 supplied to the rotating head 20 is subjected to the centrifugal force and is emitted in the form of filaments in the direction of the centrifugal force from the grooved portion 29 (plurality of grooves 27) formed on the tip end of the second inner peripheral surface 23b of the rotating head 20. The paint P1 emitted in the form of filaments is electrostatically atomized as it breaks up into droplets by the electrostatic force of the electrostatic field formed between the rotating head 20 and the workpiece W. The electrostatically atomized paint P1 is attracted and adheres to the grounded workpiece W due to the negative charge of the paint P1. The coating film P2 is thus formed on the surface of the workpiece W.

Safety Control

Typical electrostatic coating handguns that are used for electrostatic spray coating by an operator are of the type that does not use a rotating head. However, in electrostatic coating handguns of the type that uses a rotating head like the present embodiment, a protective cover is sometimes provided outside a head portion in order to prevent the head portion rotating at high speed during electrostatic coating from coming into contact with an operator etc.

In the case where electrostatic coating handguns have such a protective cover outside the rotating head, the paint scatters toward the protective cover when an increased voltage is applied to the paint in order to improve the coating efficiency. This may end up reducing the coating efficiency.

In particular, in the electrostatic coating handgun 3 of the type that does not use shaping air as in the present embodiment, it is difficult to provide a protective cover outside the rotating head 20. Since there is no air moving from the base end side (rear side) toward the tip end side (front side), coating would not be properly performed as the paint P1 emitted from the tip end of the rotating head 20 would scatter in a direction tangential to the rotation of the rotating head 20 and would adhere to the protective cover.

However, since the tip end of the rotating head 20 is machined to be sharp in order to atomize the paint P1 (the tip end of the rotating head 20 has a jagged edge as viewed from the outer peripheral surface 23c side) as shown in FIG. 3, some safety measures are required as the operator may have a cut etc. if he or she touches the rotating head 20 rotating at high speed.

In the electrostatic coating handgun 3 of the present embodiment, the output voltage of the high voltage generator 40 and the rotational speed of the rotating head 20 are controlled according to the distance between the operator or the workpiece W and the rotating head 20. Specifically, the air motor controller 7 reduces the rotational speed of the air motor 30 when the current value discharged from the rotating head 20 increases due to the movement of the electrostatic coating handgun 3 (rotating head 20) caused by an operation by the operator. Moreover, the high voltage controller 5 controls the output voltage of the high voltage generator 40 to zero and the air motor controller 7 stops the rotation of the air motor 30 when the amount of change (amount of increase) per unit time in current value discharged from the rotating head 20 is larger than a predetermined amount of change (predetermined amount of increase) or when the absolute value of the current value discharged from the rotating head 20 is larger than a predetermined value.

Moreover, the air motor controller 7 uses the brake mechanism 37 provided around the air motor 30 when stopping the rotation of the air motor 30. The brake mechanism 37 that stops the rotation of the air motor 30 by holding the rotating shaft 31 is implemented by, for example, pressing a pneumatically or hydraulically driven brake pad etc. against the rotating head 20 or the rotating shaft 31 of the air motor 30.

As described above, when the voltage of the high voltage generator 40 is approximately constant, the current value discharged from the rotating head 20 (current value flowing from the high voltage generator 40) varies according to the spatial resistance value between the workpiece W located in front of the rotating head 20, the operator, etc. and the rotating head 20. Such a spatial resistance value becomes smaller as the distance between the workpiece W, the operator, etc. and the rotating head 20 decreases (becomes shorter).

Accordingly, in the present embodiment, when the current value discharged from the rotating head 20 increases due to the movement of the rotating head 20 caused by an operation by the operator (due to the rotating head 20 approaching the workpiece W or the operator), the high voltage controller 5 sends a command to reduce the output voltage of the high voltage generator 40 in order to make this current value constant. At this time, information indicating that the current value has increased is transmitted from the high voltage controller 5 to the air motor controller 7, and in response to this information, the air motor controller 7 sends a command to reduce the rotational speed of the air motor 30. This reduces the possibility that the rotating head 20 rotating at high speed may contact the workpiece W, the operator, etc. Safety during electrostatic coating is thus ensured even in the electrostatic coating handgun 3 of the type that does not use shaping air, namely in the electrostatic coating handgun 3 in which it is difficult to provide a protective cover outside the rotating head 20.

Moreover, in a more urgent situation than a situation where the rotating head 20 normally approaches the workpiece W, the operator, etc., specifically, when the amount of change per unit time in current value (hereinafter also simply referred to as the “amount of change in current value”) is larger than the predetermined amount of change (when the rotating head 20 has rapidly approached the workpiece W, the operator, etc.) or when the absolute value of the current value is larger than the predetermined value (when the distance between the workpiece W, the operator, etc. and the rotating head 20 is extremely short), the high voltage controller 5 sends a command to control the output voltage of the high voltage generator 40 to zero and the air motor controller 7 sends a command to stop the rotation of the air motor 30. This can prevent the operator from getting an electric shock, a cut, etc. Safety during electrostatic coating is thus ensured to a greater extent.

Even when it is difficult to deal with a sudden decrease in rotational speed of the air motor 30 by merely sending an output stop command to the air motor 30, the air motor controller 7 sends a command to operate the brake mechanism 37, so that the air motor 30 can be stopped more quickly and more reliably. Safety is thus more reliably ensured.

As described above, according to the electrostatic coating handgun 3 of the present embodiment, the protective cover provided outside the rotating head 20 is omitted. This configuration improves the coating efficiency and also reduces the possibility that the rotating head 20 rotating at high speed may contact the workpiece W, the operator, etc. and thus ensures safety during electrostatic coating.

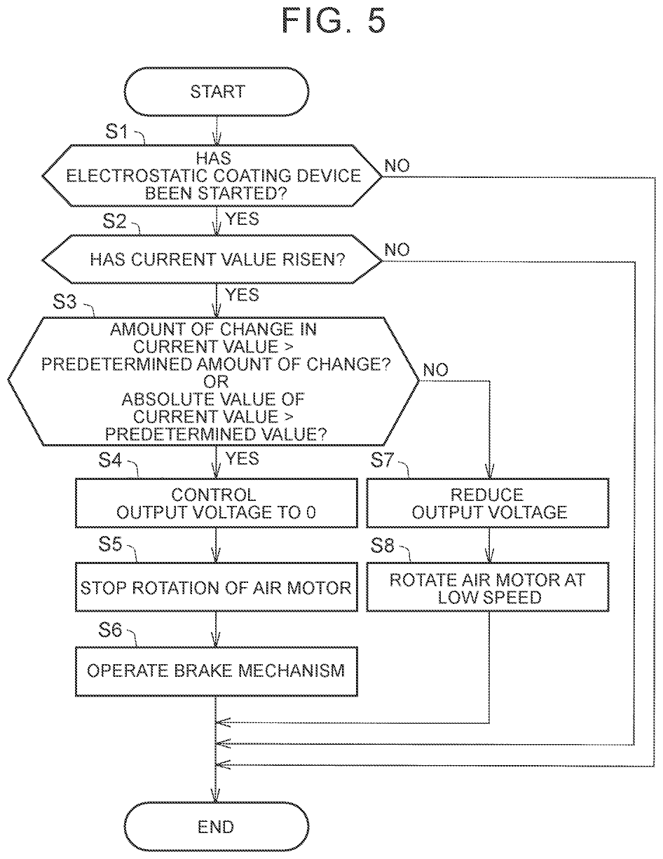

Next, safety control that is performed by the electrostatic coating device 1 will be described with reference to a flowchart shown in FIG. 5.

First, it is determined in step S1 whether the electrostatic coating device 1 has been started. In other words, it is determined in step S1 whether the rotating head 20 is rotating at high speed and whether a negative high voltage is being applied to the rotating head 20. The routine ends when the determination result of step S1 is NO. On the other hand, when the determination result of step S1 is YES, it is necessary to take safety measures. The routine therefore proceeds to step S2.

In step S2, the high voltage controller 5 determines whether the current value emitted from the open end of the rotating head 20 has risen (increased), in other words, whether the rotating head 20 has approached the workpiece W or the operator. When the determination result of step S2 is NO, the routine ends without changing the output voltage of the high voltage generator 40 and the rotational speed of the air motor 30 by the high voltage controller 5 and the air motor controller 7. On the other hand, when the determination result of step S2 is YES, the routine proceeds to step S3.

In step S3, the high voltage controller 5 determines whether the amount of change in current value discharged from the rotating head 20 is larger than the predetermined amount of change or the absolute value of the current value discharged from the rotating head 20 is larger than the predetermined value. When the determination result of step S3 is YES, in other words, when the rotating head 20 has rapidly approached the workpiece W, the operator, etc. or when the distance between the workpiece W, the worker, etc. and the rotating head 20 is extremely short, the routine proceeds to step S4.

In step S4, the high voltage controller 5 sends a command to control the output voltage of the high voltage generator 40 to zero, and the routine then proceeds to step S5. The air motor controller 7 sends a command to stop the rotation of the air motor 30 in step S5 and operates the brake mechanism 37 in step S6. The routine then ends.

On the other hand, when the determination result of step S3 is NO, in other words, when the rotating head 20 has approached the workpiece W, the operator, etc. but not rapidly, and the distance between the workpiece W, the operator, etc. and the rotating head 20 is not extremely short, the routine proceeds to step S7.

In step S7, the high voltage controller 5 sends a command to reduce the output voltage of the high voltage generator 40. The routine then proceeds to step S8. In step S8, the air motor controller 7 sends a command to rotate the air motor 30 at low speed.

The routine then ends.

### OTHER EMBODIMENTS

The present disclosure is not limited to the embodiment and can be embodied in various other forms without departing from the concept or main features of the present disclosure.

The above embodiment is described for the case where the paint P1 is a water-based paint. However, the present disclosure is not limited to this, and the paint P1 may be an oil-based paint (solvent-based paint).

In the above embodiment, the present disclosure is applied to the electrostatic coating handgun 3 of the type that does not use shaping air. However, the present disclosure is not limited to this, and the present disclosure may be applied to, for example, an electrostatic coating handgun of the type that uses shaping air.

In the above embodiment, the present disclosure is applied to the electrostatic atomization type electrostatic coating device 1. However, the present disclosure is not limited to this, and the present disclosure may be applied to an electrostatic coating device of the type (air atomization type or airless atomization type) that atomizes paint by injecting the paint from a handgun with a mechanical force (e.g., compressed air or high pressure applied to the paint) and electrically charges the atomized paint.

In the above embodiment, the electrostatic coating handgun 3 is connected to the high voltage controller 5 and the air motor controller 7 that are provided outside the electrostatic coating handgun 3. However, the present disclosure is not limited to this. For example, either or both of the high voltage controller 5 and the air motor controller 7 may be provided inside the electrostatic coating handgun 3, or the output voltage of the high voltage generator and the rotational speed of the motor may be controlled remotely.

In the above embodiment, the grip portion 13 to be held by the operator is integral with the housing 10. However, the present disclosure is not limited to this, and the grip portion 13 may be a separate member from the housing 10.

As described above, the above embodiment is merely by way of example in all respects and should not be construed as restrictive. All modifications and changes that fall within the scope equivalent to the claims fall within the scope of the present disclosure.

According to the present disclosure, both improvement in coating efficiency and safety can be achieved. The present disclosure is therefore extremely useful when applied to electrostatic coating handguns and electrostatic coating methods.

What is claimed is:

1. An electrostatic coating handgun that sprays electrically charged atomized paint onto an object to be coated, the electrostatic coating handgun comprising:
a rotating head having on a tip end of the rotating head a groove through which the paint is discharged;
a motor configured to apply rotational power to the rotating head;
a high voltage generator configured to apply a voltage to the paint;
a housing supporting the rotating head with the tip end of the rotating head being exposed, and housing the motor and the high voltage generator;
a grip portion to be held by an operator;
a voltage control device configured to reduce an output voltage of the high voltage generator when a current value discharged from the rotating head increases due to movement of the rotating head caused by an operation by the operator; and
a motor control device configured to reduce a rotational speed of the motor when the current value discharged from the rotating head increases due to the movement of the rotating head caused by the operation by the operator.

2. The electrostatic coating handgun according to claim 1, wherein the voltage control device is configured to control the output voltage of the high voltage generator to zero when an amount of change per unit time in the current value discharged from the rotating head is larger than a predetermined amount of change or when an absolute value of the current value is larger than a predetermined value, and the motor control device is configured to stop rotation of the motor when the amount of change per unit time in the current value discharged from the rotating head is larger than the predetermined amount of change or when the absolute value of the current value is larger than the predetermined value.

3. The electrostatic coating handgun according to claim 2, wherein the motor control device is configured to use a brake mechanism when stopping the rotation of the motor.

4. The electrostatic coating handgun according to claim 1, wherein the electrostatic coating handgun is configured to electrostatically atomize the paint without using shaping air.

5. An electrostatic coating method in which electrically charged atomized paint is sprayed onto an object to be coated, the electrostatic coating method comprising:
preparing an electrostatic coating handgun, the electrostatic coating handgun including a rotating head having on a tip end of the rotating head a groove through which the paint is discharged, a motor configured to apply rotational power to the rotating head, a high voltage generator configured to apply a voltage to the paint, a housing supporting the rotating head with the tip end of the rotating head being exposed, and housing the motor and the high voltage generator, and a grip portion to be held by an operator; and
reducing an output voltage of the high voltage generator by a voltage control device and reducing a rotational speed of the motor by a motor control device when a current value discharged from the rotating head increases due to movement of the rotating head caused by an operation by the operator when the operator sprays the paint onto the object to be coated by using the electrostatic coating handgun.
